(19) United States
(12) Patent Application Publication
(10) Pub. No.: US 2021/0276671 A1
(43) Pub. Date: Sep. 9, 2021

(54) Personal Watercraft

(71) Applicant: Pivot Outdoors, LLC, Greenville, SC (US)

(72) Inventor: Thomas Reid Cheatham, Greenville, SC (US)

(21) Appl. No.: 17/192,980

(22) Filed: Mar. 5, 2021

Related U.S. Application Data
(60) Provisional application No. 62/986,242, filed on Mar. 6, 2020.

(51) Int. Cl. B63B 34/10; B63H 21/17; B63H 11/00; B63H 25/00; B60L 50/60; B63B 45/02; B60D 1/01; B63B 79/40; B63B 79/10; B63B 21/64

(52) U.S. Cl. CPC B63B 34/10; B63H 21/17; B63H 11/00; B63H 25/00; B60L 50/60; B63B 2029/043; B60D 1/01; B63B 79/40; B63B 79/10; B63B 21/64; B63B 45/02

(57) ABSTRACT

A personal watercraft (PWC) is provided. The PWC includes a body having a bottom portion, a top portion covering the bottom portion, and a storage space disposed between the top and bottom portions; and a power train disposed on or in the body. The power train includes a motor, a battery, a controller, an impeller, and an impeller water pump, and is configured for moving the body through water. Further, the body and the power train collectively weigh about 150 pounds or less.

### RELATED APPLICATION

The present application claims priority to U.S. Provisional Patent Application No. 62/986,242 entitled “Personal Watercraft,” filed on Mar. 6, 2020, the entire contents of which are incorporated herein by reference.

### FIELD

The present subject matter generally relates to watercraft, and more particularly to personal watercraft.

### BACKGROUND

Personal watercraft (PWC) may be used for recreational purposes on, for example, lakes, or other bodies of water, and additionally serve as transportation in coastal communities.

### SUMMARY OF THE INVENTION

In accordance with one embodiment of the present invention, a personal watercraft is provided. The personal watercraft includes a body including a bottom portion, a top portion covering the bottom portion, and a storage space disposed between the top and bottom portions; and a power train disposed on or in the body. In addition, the power train comprises a motor, a battery, a controller or electrical control system, an impeller, and an impeller water pump, and is configured to actuate an electric motor for moving the body through water. Further, the body and the power train collectively weigh about 150 pounds or less. These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

FIG. 1 is a side view of a personal watercraft (PWC) according to one embodiment.

FIG. 2 is a top view of the PWC of FIG. 1.

FIG. 3 is a rear view of the PWC of FIG. 1.

FIG. 4 is a side view of the PWC of FIG. 1

FIG. 5 is a side view of a PWC according to another embodiment.

FIG. 6 is a side view of transportation a PWC according to one embodiment.

FIG. 7 is a block diagram of various components of a PWC.

Before any embodiments of the subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways. Also, it is to be understood that the phraseology and terminology used herein is for the purpose of description and should not be regarded as limiting.

### DETAILED DESCRIPTION

The following detailed description of example embodiments refers to the accompanying drawings. The same reference numbers in different drawings may identify the same or similar elements.

Personal watercraft (PWC), such as jet-powered jet skis, may be used for recreation, transportation, and/or the like. Oftentimes, PWC weigh more than 500 pounds, and can be difficult to store and/or transport. Moreover, gas-powered PWC pollute natural resources, and, thus, damage the environment and contribute to waste.

Some embodiments described herein provide DC-powered PWC that incorporate improved components and/or design features, which allow for more compact and extremely lightweight watercraft, while also maintaining adequate buoyancy, battery-life, and speed. In this way, a user may be able to physically carry a PWC, and, in turn, may more easily transport and/or store the PWC. Further, since 150 pounds is the maximum weight limit for national freight companies such as FedEx and UPS, providing for a PWC that weighs less than 150 pounds as contemplated by the present invention allows for shipment of the PWC directly to consumers who may purchase the PWC online. In this way, costs associated with obtaining a trailer to transport the PWC and/or costs associated with obtaining storage space for storing the PWC at a marina may be obviated. Moreover, in this way, the use of DC-powered electric motors to propel the PWC may obviate noise, pollution caused by oil and gas leaks, and/or costs associated with maintaining and/or winterizing a gas-powered PWC.

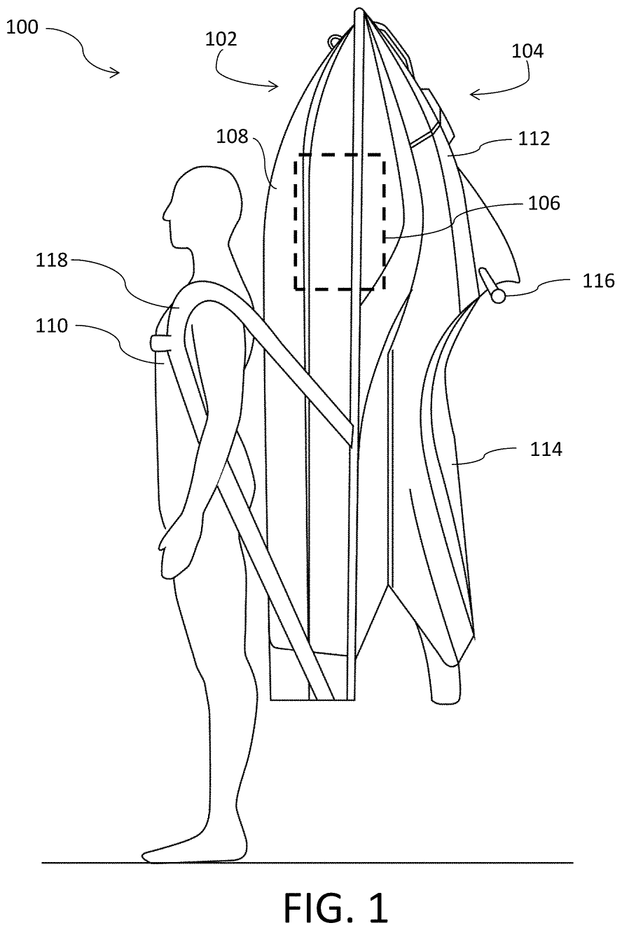

FIGS. 1-7 illustrate various aspects of a PWC, generally designated 100. Referring to FIG. 1, the PWC 100 may include a jet ski watercraft formed from various parts or portions, including at least a bottom portion 102 and a top portion 104 that covers the bottom portion 102. In some embodiments, the respective top and bottom portions 102 and 104 of the PWC 100 may each be formed from a polyolefin such as polypropylene or polyethylene (e.g., such as a high density polyethylene (HDPE), and/or the like) or other plastic resins and may be joined together via welding, sealing (e.g., via adhesive), and/or the like. In some embodiments, the top and bottom portions 102 and 104 may be separately formed and then subsequently joined together.

In other embodiments, the top and bottom portions 102 and 104 may be made via rotomolding or rotational molding in which a heated hollow mold is filled with a charge or shot weight of a plastic material from which the top and bottom portions 102 and 104 will be formed. The mold is then slowly rotated (usually around two perpendicular axes), causing the softened plastic material to disperse and stick to the walls of the mold. In order to maintain even thickness throughout the part, the mold continues to rotate at all times during the heating phase and the cooling phase to avoid sagging or deformation.

In still other embodiments, the top and bottom portions 102 and 104 may be integrally formed together as a single body, for example, as a single body of material formed by one or more sheets of polyethylene.

In some embodiments, polyethylene, when formed into a jet ski body, is advantageously buoyant. In this way, a PWC 100 formed from about 45 pounds of polyethylene may have an overall buoyancy of at least about 350 pounds. PWC 100 formed from about 45 pounds of polyethylene may have an overall buoyancy of more than and/or less than about 400 pounds in some cases. In this way, multiple persons and/or objects may be supported by the polyethylene PWC 100. Further, in this way, a single person may be able to lift and/or carry the lightweight PWC 100 as described further herein.

In some embodiments, a storage area 106, shown schematically in FIG. 1, may be at least partially disposed between the respective bottom and top portions 102 and 104 of the PWC 100. A door or cover (e.g., a hinged door or cover, not shown) may provide access to the storage area 106. As described further herein, various components and/or accessories (e.g., straps, wheels, life jackets, fishing rods, fishing rod holders, lights, and/or the like) may be stowed in the storage area 106 for safekeeping while the PWC 100 is or is not in use.

In some embodiments, the bottom portion 102 defines and/or otherwise includes a hull 108 that buoyantly supports the PWC 100 and at least one user 110 in water. In some instances, the hull 108 may be at least partially lined with an optional and additional buoyant material (e.g., foam, and/or the like) for improved buoyancy, where desired. In some embodiments, the hull 108 may additionally be substantially flat (e.g., within about +/−15° of being flat or horizontal). In this way, the PWC 100 may advantageously be used in shallow water, for example, by way of drifting in calm water (e.g., for improved fishing excursions, and/or the like), drifting near the shoreline, and/or the like. Similarly, use of a PWC 100 having a polyethylene hull 108 provides a light and nimble jet ski configured to perform tricks and/or jumps using less battery power and/or less motor torque than existing units that utilize heavier, fiberglass hulls and/or bodies. The power to weight ratio consumes less battery power which, in turn, increases performance and run time over a larger and/or heavier vessel.

In some embodiments, the top portion 104 of the PWC includes and/or is formed from a deck 112, a seat 114, and a steering unit or assembly 116. The deck 112 complements the hull 108 (e.g., in size, shape, and/or the like) and may additionally be molded from polyethylene. The hull 108 and the deck 112 may be sealed together such that water is prevented from entering spaces between the hull 108 and the deck 112. The seat 114 may be formed from polyethylene, and an optional, additional cushioning material such as, for example, a buoyant foam for improved comfort. The steering assembly 116 may include handlebars that are operatively coupled to and/or physically linked to a fin of a jet propulsion system for guiding and/or assisting in propelling the PWC 100 through water.

The space between the hull 108 and the deck 112 may additionally form or define a cavity that accommodates a power source, such as a battery (e.g., a lithium-ion battery, a lead-acid battery, an Absorption Glass Mat (AGM) battery, a gel cell battery, a wet cell battery, and/or the like), as well as one or more additional components. Such additional components may include, but are not limited to, an electric motor, an electrical control system (e.g., a controller, a microprocessor, and/or the like) configured to control aspects of the battery, the motor, an LCD display and/or other elements (e.g., one or more lights, one or more speakers, a radio, a camera, a GPS unit, and/or the like) required or desirable in the PWC 100.

In some embodiments, the battery and motor are operatively coupled or connected to or form part of a jet propulsion system or power train (not shown), which may be formed on, over, in, and/or otherwise be supported by the hull 108 for propelling the PWC 100 through water. For example, the hull 108 may define and/or include a water inlet and a channel by which water, in the form of a jet stream, may pass between the water inlet and a water outlet by way of a motor-actuated impeller and/or an impeller water pump. It is contemplated that any jet propulsion system that is designed for a PWC may be used in PWC 100. Notably, however, the steering assembly 116 may be operatively coupled to and/or attached to a removable fin for stabilizing the PWC 100. The fin may be removably coupled from the hull 108 and steering assembly 116 so that the PWC 100 may be used in shallow water, in some instances.

Still referring to FIG. 1, and in some embodiments, one or more wearable members, such as straps 118, may be removably secured and/or coupled to the PWC 100. Such straps 118 may be used to secure the PWC 100 to the user 110. In this way, the user 110 may utilize straps 118 to lift and/or carry the compact, lightweight PWC 100 and place the PWC 100 in water, or any other desired location. In some embodiments, the straps 118 may extend over and/or around the user's shoulders for comfortable lifting and carrying of the PWC 100. Opposing ends of the straps 118 may connect to the PWC 100 by way of one or more carabiners, snaps, buckles, and/or the like. Such straps 118 may be formed from any desired material (e.g., a waterproof fabric, and/or the like) and may be attachable and detachable to the PWC 100, for example, by way of being looped, hooked, or otherwise fastened to the PWC 100. Such straps 118 may be adjustable for accommodating differently sized users 110. In some embodiments, the straps 118 may be connected to a wearable garment or a wearable floatation device. Upon placing the PWC 100 in water and/or in any other desired location, the straps 118 may optionally be removed from the PWC 100, removed from the user 110, and stowed (e.g., in the storage area 106) for subsequent use. In this way, the use of a trailer for transporting the PWC 100 may be obviated. In this way, ease of transporting and/or storing the PWC 100 may be improved.

In some embodiments, the one or more of the straps 118 may additionally be used as a safety belt, harness, or tie-down line(s) for securing persons and/or cargo (e.g., tackleboxes, floats, luggage, and/or the like) to the PWC 100 when the PWC 100 is in use. In this embodiment, the straps 118 may be non-removably disposed respective to the PWC 100, and used to secure persons and/or objects to the seat 114.

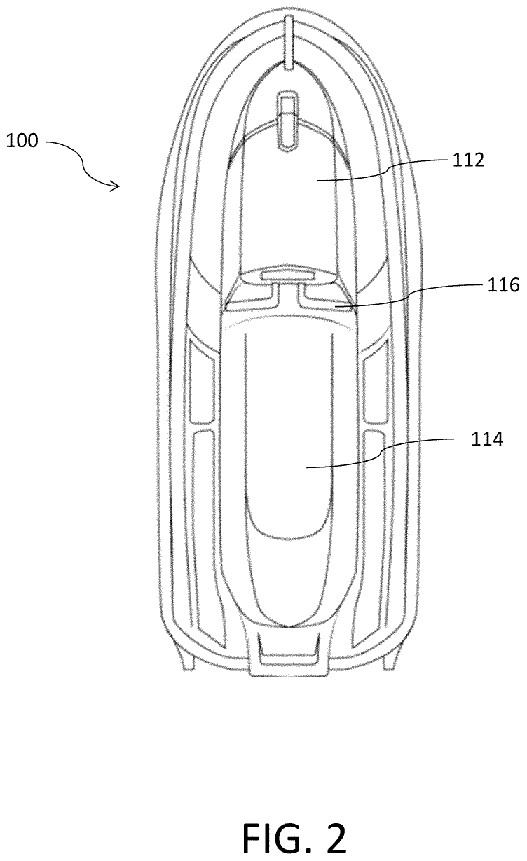

FIG. 2 is a top view of the PWC 100, which illustrates one possible layout of various components forming the PWC 100. As FIG. 2 illustrates, the seat 114 may be disposed to the rear of the deck 112 and/or be positioned behind the deck 112 such that when in use, a user may straddle the seat 114 to steer the PWC 100 using the steering assembly 116. Standup versions of a PWC 100, for example, in which a user stands up and grasps the steering assembly 116 of the PWC 100 during use are also contemplated.

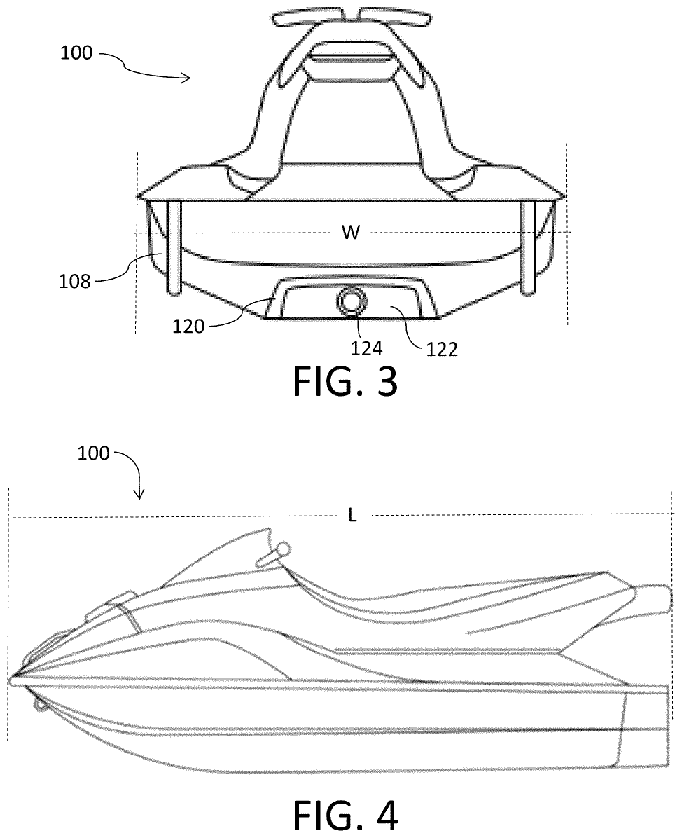

FIG. 3 is a rear view of the PWC of FIG. 1. Portions of the jet propulsion system are visible in this view. For example, the hull 108, or a portion thereof, defines and/or forms a channel 120 by and/or through which a jet stream of water may pass between a water inlet (not shown) and a water outlet 122. The jet stream of water may be used to propel the PWC 100 through a body of water, and may be generated by way of force generated by an impeller 124 and the associated impeller water pump, which may be linked and/or operatively coupled to the electric motor.

As FIG. 3 further illustrates, the PWC 100 may include maximum width W. In some embodiments, the maximum width W may be about 36 inches or less. In some embodiments, the maximum width W may be about 36 inches or less, such as about 32 inches or less. In some embodiments, the maximum width W may be about 31 inches. In some embodiments, the maximum width W may be between about 0 and 36 inches. In this way, the PWC 100 is configured in a compact size and shape. Further, in this way, the PWC 100 may be easily transported, lifted, and/or carried by a person, for example, using straps (e.g., 118, FIG. 1) or another such lifting/carrying device.

As FIG. 4 illustrates, the PWC 100 may additionally include maximum length L. In some embodiments, the maximum length L may be about 84 inches or less, such as about 76 inches or less. In some embodiments, the maximum length L may be about 74 inches or less. In some embodiments, the maximum length L may be about 71 inches. In some embodiments, the maximum length L may be between about 0 and about 84 inches. In this way, the PWC 100 is configured to have a compact length. Further, in this way, the PWC 100 may be easily transported by way of a trailer or platform that is connected to a vehicle using a vehicular trailer hitch. Further, in this way, use of a separate trailer (i.e., a pull-behind trailer having wheels) for transporting the PWC 100 may be obviated.

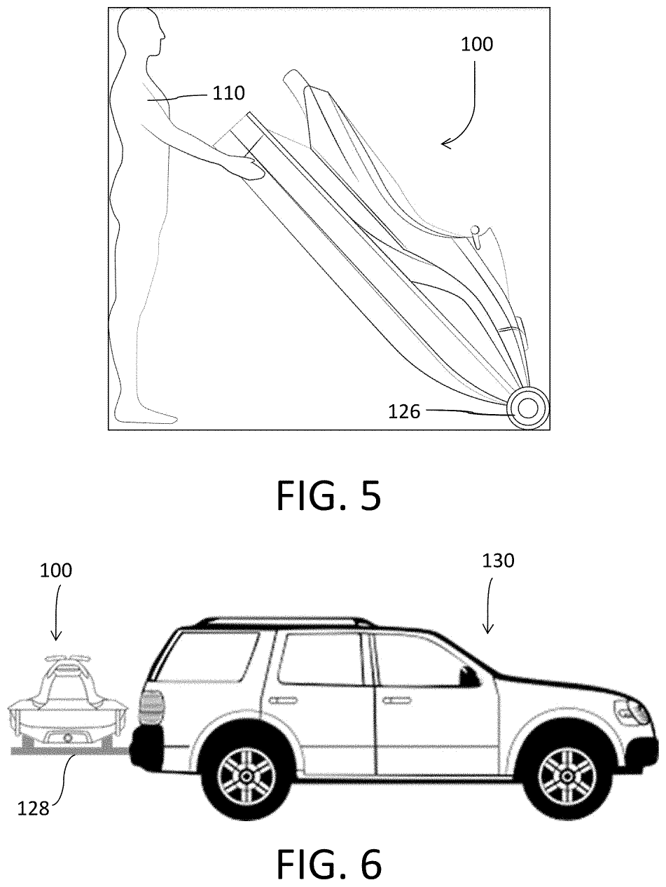

FIG. 5 illustrates additional devices and methods for transporting the PWC 100 according to one embodiment. As FIG. 5 illustrates, a user 110 may utilize at least one wheel 126 which provides leverage for lifting and, thus, transporting the PWC 100. The wheel 126 can be, but does not have to be removable. In some embodiments, the wheel 126 is temporarily affixed to the PWC 100 by way of a snap, male/female couplers, a hook, a loop, a belt, a strap, a bayonet-style coupler, and/or the like. Upon maneuvering the PWC 100 to a desired location, the wheel 126 may be removed and stowed in the storage area 106 (FIG. 1) until a later need arises. In this way, a user is able to transport the PWC 100 unassisted, and without the need for heavy equipment, machinery, and/or a separate trailer.

FIG. 6 is a side view additional devices and methods for transporting the PWC 100 according to one embodiment. As FIG. 6 illustrates, the PWC 100 may be carried and transported by way of a platform 128 extending from a vehicle 130. Such platform 128 may be attached to the vehicle 130 by way of coupling to a vehicular trailer hitch extending from the vehicle 130. In this way, the lightweight, compact PWC 100 may be easily transported without having to buy or rent a trailer. In this way, more users will have access to enjoying time spent on a PWC 100 due at least, in part, to the improved ease of carrying and transporting the PWC 100. In this way, the PWC 100 may additionally be transported to an airport and checked onto an airplane in a similar manner by which bags may be checked.

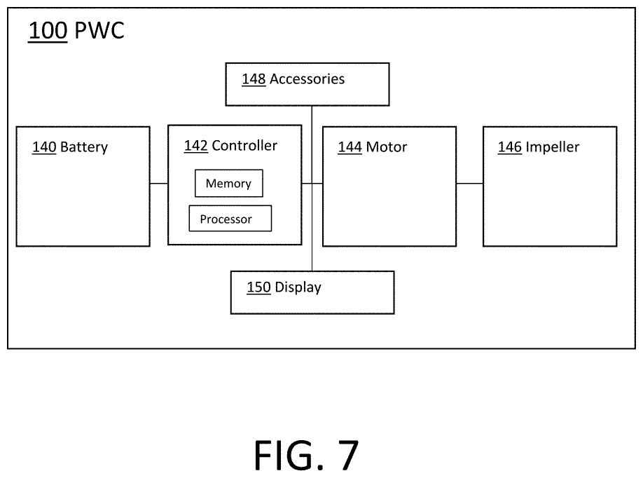

FIG. 7 is a block diagram of exemplary components comprising the PWC 100. The PWC 100 may include a battery for powering the motor and other electrically activated components or accessories. The battery may include, for example, a lithium ion battery (e.g., a 25 Amp hour (Ah) Li-ion battery, a 32 Ah Li-ion battery, and/or the like), or one or more batteries used in motorized or electric vehicles. Such a battery may include, for example, one or more 12 Volt lead-acid car batteries (e.g., the PWC 100 may incorporate 4 lead-acid car batteries), an Absorption Glass Mat (AGM) battery, a gel cell battery, a wet cell battery, and/or the like. The battery is configured to continuously power the PWC 100 for at least one continuous hour. In some embodiments, the PWC 100 may incorporate multiple batteries for a longer run-time.

The battery may be coupled to at least one controller 142 and/or control circuitry disposed on or over a printed circuit board (PCB). The controller 142 may include a memory device and a processor configured to execute logic stored in the memory for controlling aspects associated with how the battery is discharged, motor control, and functionality associated with one or more electric accessories, where used. The processor may be implemented in hardware, firmware, or a combination of hardware and software. The processor may be a microprocessor, a microcontroller, a digital signal processor (DSP), a field-programmable gate array (FPGA), an application-specific integrated circuit (ASIC), or another type of processing component. In some embodiments, the processor is capable of being programmed to perform a function. The memory device of the controller may include a random access memory (RAM), a read only memory (ROM), and/or another type of dynamic or static storage device (e.g., a flash memory, a magnetic memory, and/or an optical memory) that stores information and/or instructions for use by the processor to control aspects of the PWC 100.

The motor 144 may include an electric motor, such as a multiple stroke (e.g., 2 stroke, 4 stroke, etc.) electric brushless motor (e.g., a 52 V brushless motor, a 60 V brushless motor, a 72 V brushless motor, and/or the like). The motor 144 is configured to actuate the impeller 146 to propel the PWC 100 through a body of water. The motor is configured to propel the PWC 100 at speeds up to about 50 mph or more, in some cases.

The PWC 100 may additionally include one or more accessories 148 and a display 150. The accessories may be powered by the battery 140 and optionally controlled by the controller 142. Some accessories may include an independent controller or control circuitry therein. Example accessories include a radio, a GPS device, a camera, a speaker, a light, a Bluetooth speaker, an emergency survival radio, and/or the like. The display 150 may display useful information to the user when using the PWC 100. Such information may include, for example, the speed of the PWC 100, an indication of battery life, GPS data, emergency weather updates, time/date information, and/or the like.

### EXAMPLE

Example components associated with and forming the PWC 100, and the respective weight or weight ranges of such components, are provided in Table 1 below, and are included for reference only. The components listed in Table 1 should not be construed as the only components in the PWC 100. Nor should the components listed in Table 1 below be construed as necessary components to the design. Rather, Table 1 contains exemplary components that may be included in the PWC 100.

TABLE 1
Example PWC Components

| | Approx. Weight | Additional Qualities/ |
|---|---|---|
| PWC Part | (in pounds) | Materials |
| Body | 45 | Polyethylene |
| *Does not | | e.g., Thermoform HDPE |
| include | | sheet(s), Polypropylene, or |
| accessories | | other Polyolefins or |
| | | plastic resins |
| Battery | 20-50 | Hermetically sealed for long |
| | | term immersion |
| | | Provides approximately a 1- |
| | | hour run-time at full throttle |
| Electric | 10 | Hermetically sealed for |
| Motor | | long term immersion |
| Impeller | 5-20 | Likely constructed of |
| | | plastic, other materials |
| | | (e.g., metal, composite |
| | | materials, and/or the like) |
| | | are contemplated. |
| Controller | 1-5 | Control motor speed, |
| | | aspects of battery |
| | | discharge, accessories, etc. |
| LCD | 1-5 | Panel display unit/screen |
| Accessories | Vary | Upgraded seat (e.g., |
| | | cushioned), additional seat, |
| | | headlight, speaker, radio, |
| | | LED light(s), rear view |
| | | mirror(s), additional |
| | | battery, fishing rod holder, |
| | | etc. |

Although the present subject matter has been described in detail with reference to certain preferred embodiments, variations and modifications exist within the scope and spirit of one or more independent aspects of the subject matter as described.

What is claimed is:

1. A personal watercraft (PWC) comprising:
a body including a bottom portion, a top portion covering the bottom portion, and a storage space disposed between the top and bottom portions; and
a power train disposed on or in the body,
wherein the power train comprises a motor, a battery, a controller, an impeller, and an impeller water pump, and is configured for moving the body through water, and
wherein the body and the power train collectively weigh about 150 pounds or less.

2. The PWC of claim 1, further comprising at least one strap configured for attachment and detachment to the body, wherein the strap is configured to assist a user in carrying the PWC.

3. The PWC of claim 1, further comprising at least one wheel configured for attachment and detachment to the body, wherein the wheel is configured to assist a user in transporting the PWC.

4. The PWC of claim 1, wherein the strap and the wheel are configured to fit inside the storage space.

5. The PWC of claim 1, wherein the top portion includes a deck, a seat, and a steering assembly.

6. The PWC of claim 1, wherein the bottom portion defines a hull, a water inlet formed in the hull, and a channel in which water passes between the water inlet and a water outlet, and wherein the impeller is configured to jet the water between the water inlet and the water outlet.

7. The PWC of claim 1, wherein the bottom portion is substantially flat.

8. The PWC of claim 1, wherein a fin is attachable to and detachable from the bottom portion, wherein the fin provides stability to the PWC.

9. The PWC of claim 1, wherein the battery is at least one of a lithium-ion battery, a lead-acid battery, an Absorption Glass Mat (AGM) battery, a gel cell battery, and a wet cell battery.

10. The PWC of claim 1, wherein the PWC has a buoyancy of less than about 400 pounds.

11. The PWC of claim 1, wherein the body has a maximum length of about 84 inches or less.

12. The PWC of claim 1, wherein the body has a maximum width of about 36 inches or less.

13. The PWC of claim 1, wherein the battery is configured to continuously power the PWC for at least one hour.

14. The PWC of claim 1, further comprising at least one accessory disposed on or over the body, the at least one accessory including at least one of a headlight, a speaker, a radio, a GPS unit, a display screen, and a fishing rod holder.

15. The PWC of claim 1, wherein the PWC is transportable using a platform attached to a trailer hitch of a vehicle.
